(19) United States
(12) Patent Application Publication
(10) Pub. No.: US 2024/0225936 A9
(43) Pub. Date: Jul. 11, 2024

(54) EXERCISE APPARATUS FOR HELPING GROWTH THROUGH STRETCHING AND STIMULATION OF KNEE JOINT AREA

(71) Applicant: CAREMEDI CO., LTD., Gyeonggi-do (KR)

(72) Inventor: Seokwon LEE, Gyeonggi-do (KR)

(21) Appl. No.: 18/569,416

(22) PCT Filed: Jul. 20, 2022
(86) PCT No.: PCT/KR2022/010598

§ 371 Date: Dec. 12, 2023

(30) Foreign Application Priority Data
Jul. 23, 2021 (KR) 10-2021-0096846
Jul. 26, 2021 (KR) 10-2021-0098055
Jul. 26, 2021 (KR) 10-2021-0098101

(51) Int. Cl. A61H 1/02; A61H 1/00

(52) U.S. Cl. CPC A61H 1/024; A61H 1/005; A61H 1/0218; A61H 2201/0103; A61H 2201/10; A61H 2201/1642; A61H 2201/5056; A61H 2201/5071; A61H 2230/305; A61H 2230/505

(57) ABSTRACT

The present invention relates to an exercise apparatus for helping growth through stretching and stimulation of knee joint areas. The present invention provides a stretching effect on knee joints through movement in the direction of being spaced apart from each other or contraction in a state in which the thighs and the calves are fixedly supported using air pressure. In addition, the present invention can provide, to the popliteal part, which is the back of the knee, muscular relaxation and warming effects through warming action using far-infrared LEDs, together with any one of vibration stimulation using vibration motors disposed to flexibly come in close contact with the popliteal part, electrical stimulation using low-frequency pads, and tapping stimulation through repeated beating applied by solenoid actuators that come in contact with the popliteal part. Thus, it is possible to help the growth of growing children and adolescents. In addition to this, it is possible to alleviate knee joint diseases.

### TECHNICAL FIELD

The present invention relates to an exercise apparatus for helping growth through stretching and stimulation of knee joint areas. The present invention provides a stretching effect by a traction force on the thighs and calves and parts around the knee joints in the human body. In addition, the present invention applies vibration stimulation, low-frequency stimulation, or tapping stimulation together with warming action on the popliteal part to stimulate the muscles, ligaments, and growth plates connected to the knee joints of the growing adolescents, and relaxes the muscles around the knee joints to help growth. In particular, the present invention relates to an exercise apparatus for helping growth through stretching and stimulation of the knee joint areas to which a traction force is exerted in a close contact state over a large area in conformity with the shape of the thighs and calves.

### BACKGROUND OF THE INVENTION

In recent years, due to lack of exercise and an increase in sedentary time, problems such as abnormal development of the musculoskeletal system and poor growth have become serious in growing children and adolescents. The best way to prevent this is to strengthen the muscles around the joints or musculoskeletal system through proper exercise and stretching and treat the muscles with their self-healing power.

Meanwhile, the growth plates are the parts of limb bones where length growth takes place. The growth plates are located at both ends of a bone, and cartilage tissue is sandwiched between bones. During the fetus, all limb bones are made up of cartilage. However, as the fetus grows, a middle part of the cartilage turns into a bone and gradually spreads to both ends. This part is called the primary ossification center. In this way, cartilage cells located in a growth plate are actively dividing, and cartilage in the middle and at both ends of the bones are gradually changed into bones, and the remaining cartilage part therebetween becomes a growth plate. Then, as puberty passes, all the growth plates turn into bones, and the growth ends. Factors that influence the cell division of the cartilage cells located in the growth plates include genetic predisposition, nutrients, hormones, exercise, and mechanical stimuli. Among these, it is known that the degree of growth due to acquired influencing factors is determined by more than 70%. Accordingly, as the fetus grows into an adolescent, it's important to provide adequate nutrition, moderate exercise, and mechanical stimuli. For this purpose, various exercise methods to stimulate the growth plates of the leg bones, which are highly related to height growth, and acupressure and massage methods that can enhance a stretching effect are proposed.

However, since conventional exercise methods require regular exercise amount and time, there is a disadvantage in that it is difficult for children or adolescents struggling with schoolwork to implement such regular exercise. In the case of acupressure or massage, in most cases, it is not possible for a person receiving the therapy to perform a procedure alone. Accordingly, there are problems in that not only it is cumbersome to get help from others but also the effect is not uniform because the acupressure or massage is carried out by relying on human power. In order to improve these problems, in the related art, various types of acupressure or massage machines have been developed and used to provide self-acupressure or self-massage. Vibration massage machines that vibrate acupressure balls using a driving source, or air pressure massage machines using air pressure, are becoming mainstream.

The vibration massage machines according to the related art are of types in which the acupressure balls are vibrated using a driving source such as a vibration motor or solenoid. Most of these vibration type acupressure machines are used by repeatedly beating (tapping) a part of the body. Thus, there are disadvantages in that not only the acupressure effect is low but also secondary pain is caused by the beating. In addition, in order to properly transmit the vibration of the acupressure balls to the body, it is necessary to press the acupressure balls against body parts with a certain amount of force. Thus, there are problems in that not only it is inconvenient to use the acupressure machines but also it is difficult to use the acupressure machines continuously.

Meanwhile, the air pressure massage machines are of types in which the air pressure of the compressed air generated by a pump is repeatedly exerted on cuffs configured to wrap parts of the user's body. Most of the air pressure massage machines are configured such that pressure is repeatedly exerted on a part of the body by injecting or exhausting air into or from the cuffs adapted to wrap around body parts, such as arms, legs, or waists. Thus, there is a problem in that the stretching effect cannot be expected except for local pressurization of a part of the body.

As one related art, ‘the growth plate stimulation massage providing device that promotes growth and development’ disclosed in Korean Registered Patent No. 10-1950148 has been proposed. However, due to the complex structure and large volume of the device, there is a disadvantage in that there are restrictions depending on installation space and use space. In particular, the leg massage unit, which includes the upper air cell, the middle air cell, and the lower air cell, is just for massaging the calves. As a result, there is a disadvantage in that an effective stretching effect on the parts around the knee joints for height growth cannot be expected.

As another related art, ‘the massage device that allows stimulation and stretching of growth plates of growing adolescents’ has been proposed through Korean Registered Patent Gazette No. 10-2178061. However, this massage device should be used in a state in which a user is seated. Thus, due to the complex structure and large volume of the device, there are disadvantages in that there are restrictions on the installation place, and economical manufacture is difficult, resulting in high prices. In particular, since the air cells that wrap the user's legs are provided in the form of a pouch that is just inflated by supplying air, the air cells cannot be brought into close contact with the curvature shape of the human body. Accordingly, excessive pressure is exerted locally, causing pain or causing injury. In addition, the device has a structure in which stimulation is caused simply by the inflation and contraction actions of the air cells and the lower leg module is extended by measuring the length of the leg through sensing means. Accordingly, there is a problem in that it is difficult to provide effective stimulation to the growth plates distributed around the knee joints. For example, as the leg of the human body gradually tapers off from the thigh to the ankle, the calf part is partially convex due to the muscles. The air cells according to the related art are provided in the form of a straight tube into which a leg is inserted, or are provided in a ‘U’ shape so that a part of the leg can be rested thereon. Eventually, the air cells are not brought into close contact with the shape of the leg of the human body. Accordingly, when the air cells are inflated, a relatively higher inflation pressure is exerted on the upper parts of the thighs or calves and a relatedly lower pressure is exerted on the lower parts of the thighs or calves. Thus, it is difficult to realize a proper massage function. In addition, it is not possible to exert uniform close contact pressure on individual body parts where the upper and lower leg modules are located. Accordingly, there is a problem in that complaints due to inconvenience and pain in use are caused.

### DETAILED DESCRIPTION OF THE INVENTION

### Technical Challenges

The present invention has been invented to solve the problems of the aforementioned related art. The object of the present invention is to provide a growth plate stimulation exercise apparatus that can induce effective stimulation and relaxation of the muscles and growth points around a user's knee joint to help growth, by pulling the thigh and calf in directions apart from each other with respect to the knee to relax the muscles and ligaments by stretching together with massaging around the knee joint using air pressure and by applying any one or more than one of local vibration stimulation using a vibration motor, local electrical stimulation using a low-frequency massage machine, or tapping stimulation by repeated beating using a solenoid actuator to a popliteal part located at the back of the knee.

In addition, another object of the present invention is to provide an exercise apparatus for helping growth through stretching and stimulation of a knee joint area or an exercise apparatus that can improve the disease of a knee part. In the exercise apparatus, upper and lower limb air cells that constrain and support the user's thigh and calf can be inflated by a user placing his/her leg on upper and lower limb holders, and upper and lower limb close contact pads filled with fluid substance provided inside the upper and lower limb air cells can be appropriately deformed along a curved surface of a body while coming into contact with the body to maintain a stable close contact state.

In addition, another object of the present invention is to provide an exercise apparatus that supports growth through stretching and stimulation of the knee joint area. In the exercise apparatus, the structure can be simplified so that the apparatus can be used at any time regardless of space or place of use, thereby increasing the convenience of use and consumer satisfaction with the product.

### Means for Solving the Challenges

An exercise apparatus for helping growth through stretching and stimulation of a knee joint area according to a preferred embodiment of the present invention to realize the above object, comprises: a main body including a plate-shaped base plate that is placed on a floor, an upper limb holder that is provided above the base plate to be slidingly movable forward and backward, and has an open upper surface that accommodates a thigh of a body, and a lower limb holder that is disposed at a distance on one side of the upper limb holder, has relative displacement, and has an open upper surface that accommodates a calf; cuffs including upper and lower limb air cells that are respectively provided inside the upper and lower limb holders to wrap the thigh and the calf respectively and are inflated under air pressure from a first air pump, a first solenoid valve that is pipe-connected to each of the upper and lower limb air cells and selectively exhausts air, and upper and lower limb close contact pads that are respectively provided on outer surfaces of the upper and lower limb air cells, float according to the shape of the body and come into close contact with the body, and have therein filled with 30 to 90% of fluid substance in a liquid, gel, or granular state; a stretching module including an expandable air cell that is disposed between the upper and lower limb holders, has both ends connected to the upper and lower limb holders respectively, and is inflated by being supplied with air pressure from a pipe-connected second air pump to displace the upper and lower limb holders apart from each other, a second solenoid valve that is pipe-connected to the expandable air cell to selectively exhaust air, and a return spring that is disposed between the upper and lower limb holders and exerts an elastic force to bring the upper and lower limb holders close to each other; and a popliteal stimulation module includes a lifting spring that is provided between the upper and lower limb holders to exert an elastic support force in a vertical direction, a popliteal close contact pad that is provided above the lifting spring and has filled therein fluid substance, a stimulation generation unit that is provided on one side of an upper surface of the popliteal close contact pad and comes into contact with the popliteal part of the body to apply any one of vibration, electricity, or tapping stimulation in contact with a popliteal part of the body, and a capacitive touch sensor that is provided on one side of the stimulation generation unit to detect contact when the capacitive touch sensor comes into contact with the skin; and a controller that is circuit-connected to first and second air pressure sensors, which are installed on pipes of the first and second solenoid valves to measure internal air pressures of the upper and lower limb air cells and the expandable air cell, and the capacitive touch sensor, and the first and second air pressure sensors, to receive detected information to apply operation control signals to the first and second air pressure pumps and the first and second solenoid valves.

As a preferable feature of the present invention, the stimulation generation unit includes any one or more than one of a vibration motor that applies vibration stimulation, a low-frequency electrode that applies low-frequency electrical stimulation, or a solenoid actuator that applies tapping stimulation by repeated beating.

Another preferable feature of the present invention, the controller includes a fixation control unit as a control element that receives a detection signal from the capacitive touch sensor to inflate the upper and lower limb air cells, thereby allowing the user's thigh and calf to be constrained and fixed, that applies a control signal to the first solenoid valve so that the upper and lower air cells are filled with air, and that controls the supply until an air pressure value detected through the first air pressure sensor reaches a preset value; a traction control unit as a control element that, when the inflation of the upper and lower limb air cells by the fixation control unit is completed, applies a control signal to the second air pump to inflate the expandable air cell to space the upper and lower limb holders from each other so that a traction force is exerted, that applies the control signal to the second air pump to fill the expandable air cell with air, and that controls the supply until an air pressure value detected through the second air pressure sensor reaches a preset value; and a popliteal stimulation control unit that applies power to the stimulation generation unit to controls the stimulation to be exerted on the popliteal part when the traction operation by the traction control unit is completed.

As another preferable feature of the present invention, the controller includes a timer that measures time, and a repeated traction control unit that is connected to the second air pressure sensor and that applies a control signal to the second solenoid valve so that the upper and lower limb holders are spaced apart close to each other by exhausting 50 to 90% of the air in the expandable air cell when the supply of the air to the expandable air cell is completed, and then applies a control signal to the second air pump so that the upper and lower limb holders are displaced in directions apart from each other by re-injecting the air into the expandable air cell until the preset value is reached, thereby controlling the inflation and contraction of the expandable air cell so as to repeat by a preset number of times.

As another preferable feature of the present invention, a body temperature sensor that detects a user's body temperature is provided on one side of the main body, and the body temperature sensor is circuit-connected to the controller so that the body temperature measured by the temperature sensor is applied to the controller.

As another preferable feature of the present invention, a blood pressure sensor that detects a user's blood pressure is provided on one side of the main body, and the blood pressure sensor is circuit-connected to the controller so that the blood pressure measured by the blood pressure sensor is applied to the controller.

### Effects of the Invention

The exercise apparatus for helping growth through stretching and stimulation of the knee joint area according to the present invention has the following advantages. The upper and lower limb close contact pads filled with the fluid substance maintain a stable close contact state to the user's thigh and calf while moving appropriately along the curved surface of the body. In this state, the present invention provides a stretching effect to the knee joint through the movement of the upper and lower limb holders in directions apart from each other or in directions close to each other. In addition, the present invention can provide, to the popliteal part, which is the back of the knee, muscular relaxation and warming effects through warming action using far-infrared LEDs, together with the stimulation generation unit including at least one of vibration stimulation using a vibration motor disposed to flexibly come in close contact with the popliteal part, electrical stimulation using a low-frequency electrode, and tapping stimulation through repeated beating using a solenoid actuator. Thus, it is possible to help the growth of growing children and adolescents.

In particular, the present invention is able to maintain a uniform and stable close contact state with respect to the thighs and calves of different sizes or curved surfaces through the configuration including the close contact pads that are closely and floatingly deformed to the curvature of the human body. Thus, useful effects that can enhance satisfaction in use can be expected. That is, the thighs and calves of the body form curved surfaces, and the overall thickness of the legs decreases from the top to the bottom. However, when the air cells are inflated, the air cells are not inflated in conformity with the shape of the legs (thighs, calves). As a result, a local pressing force is exerted on a part of the body. In a case where a traction force is exerted in this state, extreme pain or discomfort is caused in the user. However, the present invention includes the close contact pads made of a silicone pouch filled with fluid substance in a gel, liquid, or granular state outside the air cell. Accordingly, in the process of contact of the close contact pads with the body, the fluid substance inside moves along the curved surface of the body. As a result, the present invention has a shape that corresponds to the curved surface of the body, and maintains the close contact state. Thus, the local pain or discomfort is not caused during traction operation.

In addition, since the degree of close contact with the vibration motor can be stably provided, vibration stimulation at a correct position is possible. Since the overall structure is simple and compact, the movement of the apparatus is free. The apparatus can be provided anywhere the user wants and be used at any time. Accordingly, the present invention has the advantage of increasing consumers' satisfaction with the product due to good convenience of use.

### BRIEF DESCRIPTION OF THE DRAWINGS

FIG. 1 is a perspective view illustrating an embodiment of an exercise apparatus for helping growth through stretching and stimulation of the knee joint area according to the present invention.

FIG. 2 is an exploded perspective view illustrating the configuration of the exercise apparatus for helping growth through stretching and stimulation of the knee joint area shown in FIG. 1.

FIGS. 3 and 4 are plan views schematically illustrating the operation of the exercise apparatus for helping growth through stretching and stimulation of the knee joint area according to the present invention.

FIG. 5 is a view illustrating the state of use of the present invention.

FIG. 6 is a block diagram illustrating the configuration of the exercise apparatus for helping growth through stretching and stimulation of the knee joint area according to the present invention.

FIG. 7 is a block diagram illustrating a control configuration of a controller in the exercise apparatus for helping growth through stretching and stimulation of the knee joint area according to the present invention.

### DESCRIPTION OF REFERENCE SIGNS

10: Main body
11: Base plate
13: Upper limb holder
15: Lower limb holder
30: Cuff
31: First pump
32: First solenoid valve
33: Upper limb air cell
35: Lower limb air cell
50: Stretching module
51: Second air pump
52: Second solenoid valve
53: Expandable air cell
55: Return spring
70: Popliteal stimulation module
70: Lifting spring
73: Popliteal close contact pad
75: Stimulation generation unit
77: Touch sensor
90: Controller
91: First air pressure sensor
92: Second air pressure sensor
93: timer
95: Fixation control unit
96: Traction control unit
97: Popliteal stimulation control unit
98: Repeated traction control unit
c: Calf
k: Popliteus (knee)
t: Thigh

### MODES FOR CARRYING OUT THE INVENTION

Hereinafter, referring to the attached drawings, the configuration and operation of an embodiment of the present invention will be described in detail. Here, repeated descriptions, known functions that may unnecessarily obscure the scope of the present invention, and specific descriptions of the configuration will be omitted so as not to make the scope of the invention obscure. The embodiment of the present invention is provided in order to describe the present invention more fully to a person with average knowledge of the art. Accordingly, the shapes and sizes of the elements in the drawings may be exaggerated for a clearer description.

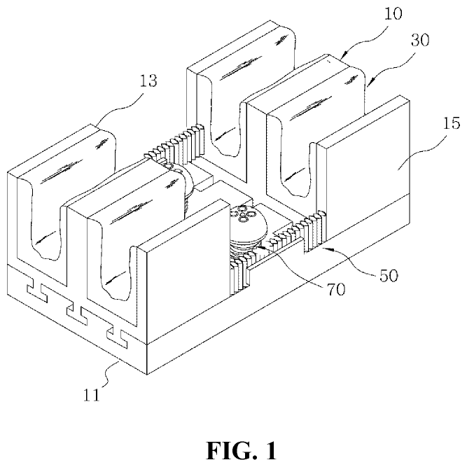

FIG. 1 is a perspective view illustrating an embodiment of the present invention.

In the drawings, an exercise apparatus is shown to help growth through stretching and stimulation of the knee joint area. The exercise apparatus comprises a main body 10 that forms an external body and includes a base plate 11 placed on a floor, and an upper limb holder 13 and a lower limb holder 15 that are provided at a distance above the base plate 11 so as to be slidingly movable back and forth and provided to accommodate the thighs and calves of the body from above by opening an upper surface; cuffs 30 that are respectively installed inside the upper limb holder 13 and the lower limb holder 15 constituting the main body 10 to constrain and fix the thighs and calves of a user under air pressure; a stretching module 50 that is provided between the upper limb holder 13 and the lower limb holder 15 to perform the traction of pulling the thighs and calves in opposite directions by moving the upper limb holder 13 and the lower limb holder 15 apart from each other or close to each other in corresponding directions; and a popliteal stimulation module 70 that is installed between the upper limb holder 13 and the lower limb holder 15 to apply physical stimulation or electrical stimulation to a popliteal part, which is the back of the knee, among the user's body part.

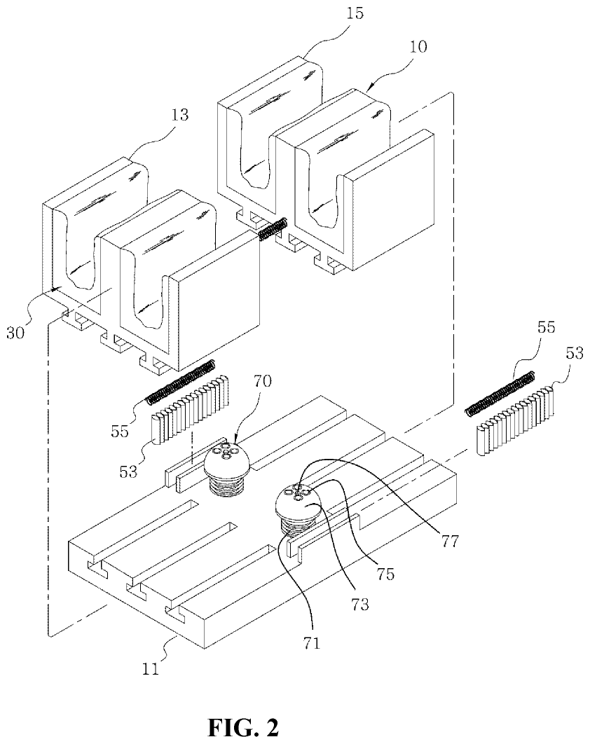

FIG. 2 is an exploded perspective view illustrating the configuration of FIG. 1.

In the drawings, there is shown the main body 10 that forms the external body and includes the base plate 11 formed with a plurality of rail grooves (not signed) in a longitudinal direction on the upper surface, the upper limb holder 13 that is provided above the base plate 11 so as to be slidingly movable back and forth along the rail grooves (not signed) and has a shape that is open on the upper surface and front and back surfaces of the base plate 11 so as to accommodate the user's thighs, and the lower limb holder 15 that has a relative displacement on one side of the upper limb holder 13 and has a shape that is open on the upper surface and the front and back surfaces so as to accommodate the user's calf parts. In addition, each of the upper limb holder 13 and lower limb holder 15 is provided with the cuff 30 for exerting a constraint and fixation force on each of the user's thigh and calf parts. The upper limb holder 13 includes an upper limb air cell 33 and an upper limb close contact pad 37. The lower limb holder 15 includes a lower limb air cell 35 and a lower limb close contact pad 39. The upper and lower limb air cells 33, 35 are configured to be pipe-connected to a first air pump (not shown) and a first solenoid valve (not known) respectively and to be supplied with air pressure or exhaust supplied air. The upper and lower limb close contact pads 37, 39 are provided as flexible and elastic pouch-shaped members such as silicone or urethane filled with 30 to 90% of fluid substance such as liquid, granules, or gel inside.

In addition, the stretching module 50 is configured to include an expandable air cell 53 that is disposed on each side of the base plate 11 so as to push the upper limb holder 13 and the lower limb holder 15 in directions apart from each other or to return the upper limb holder 13 and the lower limb holder 15 in directions close to each other, a second air pump 51 that supplies air to the expandable air cell 53, a second solenoid valve 52 that exhausts the air filled in the expandable air cell 53, and a return spring 55 that exerts an elastic support force so as to return to its original position when the air in the expandable air cell 53 is exhausted. The stretching module 50 is operated after the thighs and calves, which are the user's body parts, are completely constrained and fixed by the cuffs 30.

In addition, between the upper limb holder 13 and the lower limb holder 15 is configured a popliteal stimulation module 70 that is fixedly installed above the base plate 11 to apply vibration stimulation, electrical stimulation, or tapping stimulation to the user's popliteal part. In this case, the popliteal stimulation module 70 includes a lifting spring 71 that exerts an elastic support force in a vertical direction, and a popliteal close contact pad 73 that is provided above the lifting spring 71 and is filled with fluid substance in the form of gel, liquid, or granules inside. The upper surface of the popliteal close contact pad 73 is configured to include a touch sensor 77 that detects whether or not the body comes into contact with one or a plurality of stimulation generation units 75. Here, the stimulation generation unit 75 is an element that applies stimulation to the popliteal part of the user. A motor for vibration stimulation that is supplied with power to generate vibration, a low-frequency electrode that is supplied with power to generate electrical stimulation, or a solenoid actuator that is supplied with power to apply tapping stimulation caused through physical repeated beating to the popliteal part may be used in the present invention.

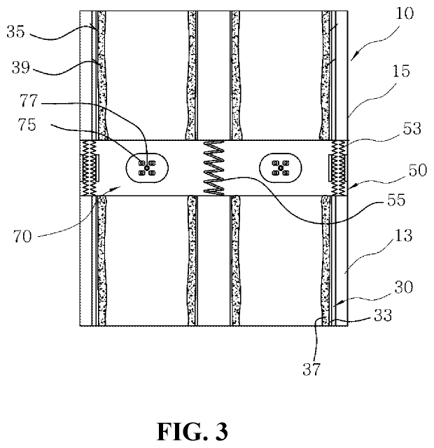

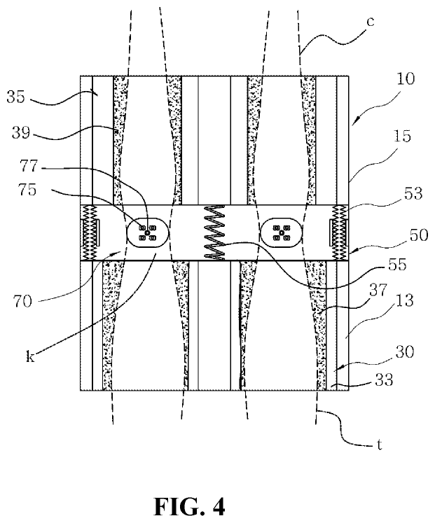

FIG. 3 shows an initial state in which the upper limb holder 13 and the lower limb holder 15 are moved close to each other. FIG. 4 shows a state in which the upper limb holder 13 and the lower limb holder 15 are spaced in directions apart from each other, that is, a traction state. In the drawings, there is shown an exercise apparatus for helping growth through stretching and stimulation of the knee joint area. This exercise apparatus comprises: the main body 10 that forms the external body and includes the upper limb holder 13 and the lower limb holder 15 provided to be slidingly movable in up and down directions based on the drawings; the cuffs 30 including the upper limb air cell 33 and the lower limb air cell 35 that are respectively provided inside the upper limb holder 13 and lower limb holder 15 and to constrain and fix the thighs and calves that are the user's body parts; the stretching module 50 including the expandable air cell 53 and the return spring 55 that are disposed between the upper limb holder 13 and the lower limb holder 15 to push the upper limb holder 13 and the lower limb holder 15 from each other so as to slidingly move the upper limb holder 13 and the lower limb holder 15 in opposite directions or to return the upper limb holder 13 and the lower limb holder 15 to their original positions; and the popliteal stimulation module 70 including the stimulation generation unit 75 and the touch sensor 77 that apply vibration stimulation, electrical stimulation, or tapping stimulation to the popliteal part, which is the back of the user's knee.

Here, as long as the stimulation generation unit 75 is an element that applies stimulation to the user's popliteal part, various known techniques may be applied. In the present invention, as a preferred embodiment, a motor that is supplied with power to generate vibration to apply vibration stimulation may be used, or any one or more than one of a low-frequency electrode that is supplied with power to apply the electrical stimulation of stimulating the muscles with a very low current to gently induce the contraction and relaxation of the muscles, or a solenoid actuator that is supplied with power to perform repeated beating using a plunger driven around a coil to perform tapping on the popliteal part may be used.

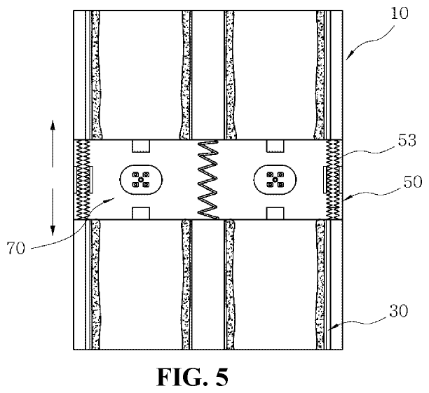

FIG. 5 is a view illustrating the state of use of the present invention.

In the drawings, there is shown a configuration comprising: the upper and lower limb air cells 33, 35 that perform uniform close contact with the user's thigh and calf parts and is inflated by being supplied with air from the first air pump 31; and the cuffs 30 that are integrally provided on one sides of the upper and lower limb air cells 33, 35 and include the upper and lower limb close contact pads 37, 39, such as pouches or bags made of a silicone or urethane material filled with 30 to 90% of fluid substance such as gel, liquid, or granules inside. In the present invention, due to the fluid substance filled inside the upper and lower limb close contact pads 37, 39, the upper and lower limb close contact pads 37, 39 are deformed along the shape of the curved surface of the thighs or calves of the body as shown in the drawings. As a result, the inflation pressure of the upper and lower limb air cells 33, 35 is in uniform and stable close contact state with the entire contact part of the body by the upper and lower limb close contact pads 37, 39.

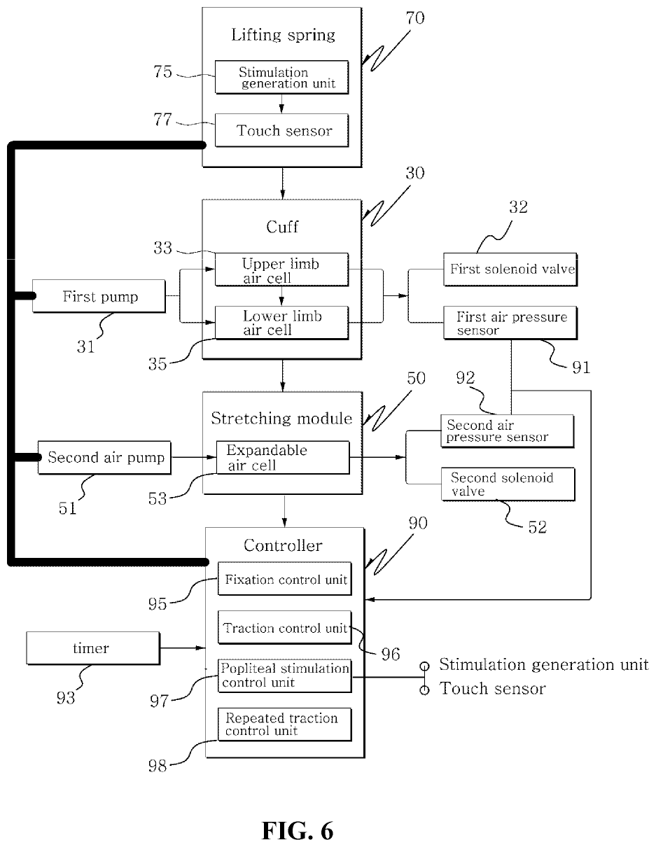

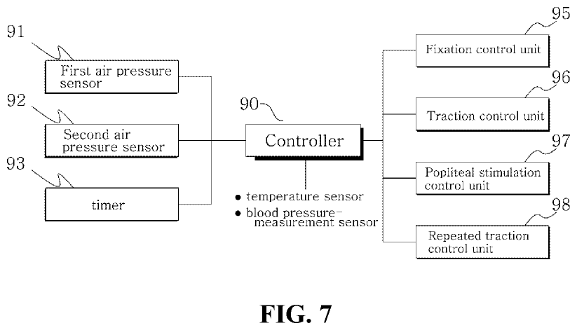

FIG. 6 is a block diagram illustrating the configuration of the present invention. FIG. 7 is a block diagram illustrating a control configuration of the controller in the present invention.

In the drawings, there is shown a control configuration including the upper and lower limb air cells 33, 35 that are installed on the pipes of the first solenoid valve 32 and the second solenoid valve 52; a first air pressure sensor 91 and a second air pressure sensor 92 that measure the internal air pressure of the expandable air cell 53; and a controller 90 that is circuit-connect to the first air pressure sensor 91 and the second air pressure sensor 92 and receives detected information to apply signals for controlling the operation to the first air pump 31, the second air pump 51, the first solenoid valve 32, the second solenoid valve 52.

The controller 90 in the present invention includes a fixation control unit 95 that controls the supply of air to the upper and lower limb air cells 33, 35 based on a detection signal of the touch sensor 77; a traction control unit 96 that controls the stretching module 50 that generates a stretching effect by widening a gap between the upper limb holder 13 and the lower limb holder 15 so that a traction force of pulling the user's thighs and calves in opposite directions is exerted; a popliteal stimulation control unit 97 that applies a control signal to the vibration motor, the low-frequency electrode, or the solenoid actuator so as to apply vibration stimulation or electrical stimulation to the popliteal part of the user's body, which is the back of the knee; and a traction control unit 96 that repeats air injection to and exhaust from the expandable air cell 53 to provide stretching and massaging.

Referring to the above drawings, the configuration of the exercise apparatus for helping growth through stretching and stimulation of the knee joint area according to the present invention will be described.

The present invention generally comprises the main body 10 that forms the external body to provide a space for various components and electrical components to be mounted and includes the upper and lower limb holders 13, 15 that have a shape that is open on the front and back surfaces and the upper surface so as to accommodate the thigh (t) and calf (c) of the user's body, respectively; the cuffs 30 that are installed in the main body 10 and temporarily constrain and fix the thigh (t) and calf (c) among the body parts of the user, using air pressure; the stretching module 50 that adjusts the gap between the upper limb holder 13 and the lower limb holder 15, using air pressure and the return spring 55; the popliteal stimulation module 70 that applies vibration stimulation or electrical stimulation to the popliteal part, which is the back of the knee, among the body parts of the user; and finally, the controller 90 that is a control element for controlling the operation.

The main body 10 includes the base plate 11 having a plate shape to be placed on the floor, and the upper limb holder 13 and the lower limb holder 15 that are provided above the base plate 11 and assembled so as to be slidingly movable in forward and backward directions.

The base plate 11 is provided in a plate shape by injection-molding a synthetic resin material. Anti-slip pads or protrusions made of a friction material for preventing slip are provided on the lower surface of the base plate 11. A plurality of rail grooves (not signed) are formed in the longitudinal direction above the base plate 11 to guide the upper and lower limb holders 13, 15 (to be described below) in the forward and backward directions.

The upper limb holder 13 is formed with corresponding rail protrusions (not signed) that are seated above the base plate 11 and are fitted into the rail grooves so as to allow slide movement. The upper limb holder 13 has a shape that is open on the upper surface and the front and back surfaces so as to accommodate the thigh (t) among the user's body parts.

The lower limb holder 15 is disposed at a distance on one side of the upper limb holder 13, likewise slidingly fitted into the rail grooves of the base plate 11 and is provided to be displaceable in the forward and backward directions, and has a shape that is open on the upper surface and the front and back surfaces so as to accommodate the calf (c) among the user's body parts.

The upper and lower limb holders 13, 15 are moved close to each other or moved apart from each other in opposite directions by the stretching module 50 to be described below, thereby exerting a traction force on the user's thigh (t) and calf (c).

The cuffs 30 are elements that are respectively provided inside the upper limb holder 13 and the lower limb holder 15 and tightly press, constrain, and fix the thigh (t) and calf (c) using air pressure. The upper limb air cell 33 and the upper limb close contact pad 37 are provided inside the upper limb holder 13. The lower limb air cell 35 and the lower limb close contact pad 39 are provided inside the lower limb holder 15.

The upper limb air cell 33 is a kind of airbag that is pipe-connected to the first air pump 31 and is inflated by being supplied with air pressure. The upper limb air cell 33 may be bonded and fixed to the inner side of the upper limb holder 13 and be inflated in the form of wrapping the back and both sides of the thigh (t) of the body when air pressure is supplied. The upper limb air cell 33 is configured to be pipe-connected to the first solenoid valve 32 to exhaust the filled air pressure to the outside. In this case, the first solenoid valve 32 is configured to be operated by receiving a control signal from the controller 90 to be described below. Since this configuration is carried out by the known technique, detailed descriptions will be omitted.

The upper limb close contact pad 37 is a sealed pocket-like member that is integrally provided on the inner side of the upper limb air cell 33 and has flexibility and elasticity. The interior of the upper limb close contact pad 37 is filled with 30 to 90% of the fluid substance in a liquid, gel, or granular state. When an external force is applied to such an upper limb close contact pad 37, the internal fluid substance is easily moved, and shape displacement occurs easily. The upper limb close contact pad 37 is deformed so that the internal fluid substance flows along the curved surface of the thigh (t) when the upper limb air cell 33 is inflated in a state in which the user's thigh (t) is accommodated therein. That is, since the upper limb air cell 33 is provided in the form of a tube made of synthetic resin fabric, there is a disadvantage in that the upper limb air cell 33 does not generate a uniform pressing force in response to the curved surface of the body when inflated by air pressure.

For example, the thigh of the body becomes thicker and thicker from a part just above the knee toward the hip. In the case of normal air cells, when inflation is caused by air pressure, relatively higher air pressure is exerted on a part closer to the hip that is thicker than the part just above the knee, causing local pain and discomfort. This makes it impossible to perform constraint and fixation in uniform close contact with the entire thigh (t) during traction.

Accordingly, the present invention comprises the upper limb close contact pad 37 inside the upper limb air cell 33 to eliminate such nuisance. This upper limb close contact pad 37 is able to compensate for the curved part of the body as shown in FIG. 5 as the shape deformation caused by the internal fluid substance is free.

Similar to the upper limb air cell 33, the lower limb air cell 35 is configured to be pipe-connected to the first air pump 31 and the first solenoid valve 32 and be inflated by being supplied with air pressure or exhaust the air inside to the outside. The lower limb air cell 35 may be bonded and fixed on the inner side of the lower limb holder 15 and be inflated in the form of wrapping the back and both sides of the calf (c) of the body when air pressure is supplied.

The lower limb close contact pad 39 is provided in the form of a sealed pocket that is integrally provided on the inner side of the lower limb air cell 35. Preferably, a pouch made of silicone or urethane may be used. The lower limb air cell 35 is filled with 30 to 90% of the fluid substance in a liquid, gel, or granular state inside. The lower air cell 35 is easily deformed by an external force due to the fluid substance. That is, the thickness gradually increases from the ankle part of the body to the calf. When air pressure is supplied to the lower limb air cell 35, the lower limb close contact pad 39 is uniformly brought into close contact with the entire calf, and the fluid substance inside is moved along the curved surface of the body. As a result, as shown in FIG. 5, uniform close contact is achieved throughout by compensating for the curved part.

The stretching module 50 is an element that is disposed between the upper limb holder 13 and the lower limb holder 15 to push the upper limb holder 13 and the lower limb holder 15 in directions apart from each other or to return the upper limb holder 13 and the lower limb holder 15 to their original positions close to each other, and generally includes the expandable air cell 53 and the return spring 55.

A plurality of the expandable air cells 53 are configured to be installed at positions that do not interfere with a space where the user's thigh (t) and calf (c) are placed. Each expandable air cell 53 is a traction element that is inflated by being supplied with air pressure from the pipe-connected second air pump 51 and slidingly moves the upper limb holder 13 and the lower limb holder 15 apart from each other.

Such an expandable air cell 53 is configured to be pipe-connected to the second solenoid valve 52 so that the filled air inside can be exhausted to the outside. In this case, the second solenoid valve 52 receives a control signal from the controller 90 to be described below, and performs a valve opening and closing operation. Since this may be carried out by the known technique, detailed descriptions will be omitted.

The return spring 55 is installed at a position that does not interfere with the expandable air cell 53. The return spring 55 is an element that moves the upper limb holder 13 and the lower limb holder 15 close to each other by exerting an elastic contraction force when the internal air pressure is exhausted by the second solenoid valve 52 in a state in which the expandable air cell 53 is inflated. As long as such a return spring 55 has the characteristic of providing the elastic contraction force, various known techniques can be applied. In the present invention, a coil spring type is proposed as a preferred embodiment.

The popliteal stimulation module 70 is provided in the space between the upper limb holder 13 and the lower limb holder 15. The popliteal stimulation module 70 is disposed above the base plate 11 where the popliteal part is located when the user rests his/her leg on the upper limb holder 13 and the lower limb holder 15. The popliteal stimulation module 70 includes: a lifting spring 71 that exerts an elastic support force in the vertical direction; and the popliteal close contact pad 73 that is provided above the lifting spring 71; the stimulation generation unit 75 and the touch sensor 77 that are provided above the popliteal close contact pad 73.

As shown in the drawings, the lifting spring 71 has a lower part fixed to the base plate 11 and an upper part provided in a vertically upward direction. The lifting spring 71 acts as an elastic support so that the touch sensor 77 can come into contact with any of the vibration motor, the low-frequency electrode, or the solenoid actuator provided as the stimulation generation unit 75 in the popliteal part when the user rests his/her leg on the main body 10.

The popliteal close contact pad 73 has an expanded volume above the lifting spring 71. The interior of the popliteal close contact pad 73 is filled with the fluid substance such as granules, liquid, or gel. As an outer shell of the popliteal close contact pad 73, a flexible and elastic material such as silicone or urethane is used. The interior of such a popliteal close contact pad 73 may be provided with a warming element such as a heater or LEDs that generate heat by being supplied with power from the outside.

The stimulation generation unit 75 is intended to apply stimulation to the popliteal part, which is the back part of the user's knee. In the present invention, any one or a combination of more than one of the vibration motor, the low-frequency electrode, and the solenoid actuator may be used.

Meanwhile, the vibration motor among the elements, which can be provided as the stimulation generation unit 75, is an element that is supplied with power from the outside to apply physical vibration stimulation. The vibration motor is configured to be operated by receiving a control signal from the controller 90 to be described below. One or a plurality of such vibration motors are provided on one side of the upper surface of the popliteal close contact pad 73 and are configured to come into contact with the popliteal part of the body. Since this configuration may be carried out by the known technique, detailed descriptions will be omitted.

In addition, the low-frequency electrode is an element that is supplied with power from the outside to apply electrical stimulation. The low-frequency electrode is configured to be operated by receiving a control signal from the controller 90 to be described below. One or a plurality of such low-frequency electrodes are provided on one side of the upper surface of the popliteal close contact pad 73 and is configured to come into contact with the popliteal part of the body. Since this configuration may be carried out by the known technique, detailed descriptions will be omitted.

In addition, the solenoid actuator is provided in an axisymmetric structure and includes a plunger driven around a coil to which an electric current is applied, a case that surrounds the outside of the plunger, and a core inside the coil. The plunger is projected or retracted by a magnetic force generated in a gap between the plunger and the core. A beating body provided at the end of the plunger is configured to apply physical tapping stimulation to the popliteal part. The beating body is configured to operate under the application of a control signal from the controller 90 to be described below. One or a plurality of such solenoid actuators are provided on one side of the upper surface of the popliteal close contact pad 73 and are configured to form beating acupressure balls so that the end of a plunger rod comes into contact with the popliteal part of the body. Since this configuration may be carried out by the known technique, detailed descriptions will be omitted.

The touch sensor 77 is provided as a capacitive sensor that detects contact with the skin of the human body. The touch sensor 77 is provided on one side of the upper surface of the popliteal close contact pad 73 so as not to interfere with the vibration motor, the low-frequency electrode, or the solenoid actuator that constitutes the stimulation generation unit 75. The touch sensor 77 is configured to be circuit-connected to the controller 90 to apply a detection signal to the controller 90 to be described below. Since this configuration may be carried out by the known technique, detailed descriptions will be omitted.

The controller 90 is a control element that is connected to the first air pressure sensor 91 and the second air pressure sensor 92, which are installed on the pipes of the first solenoid valve 32 and the second solenoid valve 52 to measure the internal air pressure of the upper limb air cell 33, the lower limb air cell 35, and the expandable air cell 53, and the timer 93 that measures time, and applies signals for operation control to the first air pump 31, the second air pump 51, the second solenoid valve 32, the second solenoid valve 52, and the stimulation generation unit 75 including any one or more than one of the vibration motor, the low-frequency electrode, or the solenoid actuator. The controller 90 generally includes the fixation control unit 95, the traction control unit 96, the popliteal stimulation control unit 97, and a repeated traction control unit 98.

The fixation control unit 95 is an element that receives a detection signal from the capacitive touch sensor 77 and inflates the upper limb air cell 33 and the lower limb air cell 35, thereby allowing the user's thigh (t) and calf (c) in contact with the upper limb close contact pad 37 and the lower limb close contact pad 39 to be constrained and fixed. That is, when the user's body contact is detected from the capacitive touch sensor 77, the fixation control unit 95 applies a control signal to the first solenoid valve 32 to generate air pressure to supply the air pressure to the upper limb air cell 33 and the lower limb air cell 35.

In addition, the fixation control unit 95 is circuit-connected to the first air pressure sensor 91, which measures the internal air pressure of the upper limb air cell 33 and the lower limb air cell 35, and is provided with real-time pressure values. The first air pump 31 is driven and controlled until the air pressures in the upper limb air cell 33 and the lower limb air cell 35 reach a preset value.

The fixation control unit 95 of this configuration inflates the upper limb air cell 33 and the lower limb air cell 35 to perform constraint and fixation of the user's thigh (t) and calf (c) when the user puts his/her leg on the main body 10 and brings the popliteal part 77, which is the back of the knee, into contact with the touch sensor 77.

When the inflation of the upper limb air cell 33 and the lower limb air cell 35 is completed by the fixation control unit 95, the traction control unit 96 applies a control signal to the second air pump 51 so that air pressure is supplied to the expandable air cell 53. In this case, the internal air pressure of the expandable air cell 53 is measured in real-time by the second air pressure sensor 92. Accordingly, the traction control unit 96 of the present invention drives and controls the second air pump 51 by comparison-processing air pressure values measured through the second air pressure sensor 92 until an air pressure value reaches a preset value.

The traction control unit 96 of this configuration is adapted to be displaced in a direction in which the upper limb holder 13 and the lower limb holder 15 are moved away from each other, by inflating a plurality of the expandable air cells 53. As a result, the user's thigh (t) and calf (c) are pulled in opposite directions, respectively, to provide a stretching effect by the traction force.

The popliteal stimulation control unit 97 is a control element that applies power to the stimulation generation unit 75 when the traction operation by the traction control unit 96 is completed, so that stimulation to the popliteal part is performed. In the present invention, a configuration in which the popliteal stimulation control unit 97 is operated after the operation by the traction control unit 96 is completed is illustrated. However, the present invention is not limited to this, and it is possible to adopt a configuration in which the vibration motor is operated after the operation of the fixation control unit 95 is completed.

That is, taking a case where the stimulation generation unit 75 is a vibration motor as an instance, the popliteal stimulation control unit 97 is an element that outputs a control signal for applying power to the vibration motor to perform physical vibration stimulation to the popliteal part. In addition, describing a case where the stimulation generation unit 75 is a low-frequency electrode, the popliteal stimulation control unit 97 outputs a control signal for applying power to the low-frequency electrode to perform electrical stimulation to the popliteal part. In addition, describing a case where the stimulation generation unit 75 is a solenoid actuator, the popliteal stimulation control unit 97 outputs a control signal for applying power to the solenoid actuator to perform tapping stimulation through the operation of repeatedly projecting or retracting the plunger and rod with respect to the popliteal part.

The repeated traction control unit 98 is a control element that enhances the stretching effect by repeating the following operation. That is, when the filling of air into the expandable air cell 53 connected to the second air pressure sensor 92 is completed, the repeated traction control unit 98 applies a control signal to the second solenoid valve 52 to move the upper limb holder 13 and the lower limb holder 15 in directions close to each other so that 50 to 90% of the air in the expandable air cell 53 is exhausted. Next, after a certain period of time, air is re-injected into the expandable air cell 53 until the preset value is reached, so that the upper limb holder 13 and the lower limb holder 15 are moved away from each other again in directions apart from each other. That is, the repeated traction control unit 98 is connected to the timer 93 and applies control signals to the second air pump 51 and the second solenoid valve 52 so that air is injected into or exhausted from the expandable air cell 53 for a set time.

Meanwhile, the present invention may further comprise a body temperature sensor that detects the temperature of the user's calf or thigh part. Such a body temperature sensor may be programmed in and controlled by the controller 90 such that the first and second solenoid valves 32, 52 are opened to exhaust the air in the upper limb air cell 33 and the lower limb air cell 35 and the driving of the popliteal stimulation module 70 is stopped so that the operation of the apparatus is stopped in a case where the user's body temperature is measured at certain time intervals and a sudden change in body temperature occurs.

In addition, in addition to the body temperature sensor, a blood pressure measurement sensor (not shown) may be configured. Similar to the body temperature sensor, such a blood pressure measurement sensor may be configured so that, in a case where the user's blood pressure is measured at certain time intervals and a sudden change in blood pressure occurs, the operation of the apparatus is stopped, a warning sound is output, and an LED lamp or the like is turned on to ensure the stability of use.

In the exercise apparatus for helping growth through stretching and stimulation of the knee joint area according to the present invention configured as described above, the user locates his/her leg on the main body 10, but locates his/her leg so that his/her popliteal part can come into contact with the popliteal stimulation module 70 in a state in which the thigh (t) part can enter the upper limb holder 13 and the calf (c) part can enter the lower limb holder 15. Subsequently, when the leg is lowered, the popliteal part is touched and detected by the touch sensor 77 constituting the popliteal stimulation module 70.

Subsequently, the controller 90 circuit-connected to the touch sensor 77 supplies air to the upper limb air cell 33 and the lower limb air cell 35 provided inside the upper limb holder 13 and the lower limb holder 15 to constrain and fix the thigh (t) and the calf (c).

When the constraint and fixation of the user's thigh (t) and calf (c) is completed, the controller 90 applies a control signal to the stretching module 50 to supply air pressure to the expandable air cell 53 so that the upper limb holder 13 and the lower limb holder 15 are moved each other in opposite directions. As a result, the thigh (t) and calf (c) parts are pulled in opposite directions with respect to the knee of the user's body to provide stimulation by stretching.

In addition, with the above stretching effect, the controller 90 applies a control signal to the popliteal stimulation module 70 to drive the stimulation generation unit 75 (the vibration motor, the low-frequency electrode, or the solenoid actuator). As a result, by exerting warmth together with vibration stimulation or electrical stimulation on the popliteal part of the knee joint, it is possible to provide complex and appropriate stimulation to the knee joint and surrounding muscles thereof, and growth plates.

In particular, the present invention enables safe use because the operation is driven after the detection of the touch sensor 77. The upper limb close contact pad 37 and the lower limb close contact pad 39 can maintain uniform close contact and fixation to the curved thigh (t) and calf (c).

1. An exercise apparatus for helping growth through stretching and stimulation of a knee joint area comprising:
a main body including a plate-shaped base plate that is placed on a floor, an upper limb holder that is provided above the base plate to be slidingly movable forward and backward, and has an open upper surface that accommodates a thigh of a body, and a lower limb holder that is disposed at a distance on one side of the upper limb holder, has relative displacement, and has an open upper surface that accommodates a calf;
cuffs including upper and lower limb air cells that are respectively provided inside the upper and lower limb holders to wrap the thigh and the calf respectively and are inflated under air pressure from a first air pump, a first solenoid valve that is pipe-connected to each of the upper and lower limb air cells and selectively exhausts air, and upper and lower limb close contact pads that are respectively provided on outer surfaces of the upper and lower limb air cells, float according to the shape of the body and come into close contact with the body, and have therein filled with 30 to 90% of fluid substance in a liquid, gel, or granular state;
a stretching module including an expandable air cell that is disposed between the upper and lower limb holders, has both ends connected to the upper and lower limb holders respectively, and is inflated by being supplied with air pressure from a pipe-connected second air pump to displace the upper and lower limb holders apart from each other, a second solenoid valve that is pipe-connected to the expandable air cell to selectively exhaust air, and a return spring that is disposed between the upper and lower limb holders and exerts an elastic force to bring the upper and lower limb holders close to each other; and
a popliteal stimulation module includes a lifting spring that is provided between the upper and lower limb holders to exert an elastic support force in a vertical direction, a popliteal close contact pad that is provided above the lifting spring and has filled therein fluid substance, a stimulation generation unit that is provided on one side of an upper surface of the popliteal close contact pad and comes into contact with the popliteal part of the body to apply any one of vibration, electricity, or tapping stimulation in contact with a popliteal part of the body, and a capacitive touch sensor that is provided on one side of the stimulation generation unit to detect contact when the capacitive touch sensor comes into contact with the skin; and
a controller that is circuit-connected to first and second air pressure sensors, which are installed on pipes of the first and second solenoid valves to measure internal air pressures of the upper and lower limb air cells and the expandable air cell, and the capacitive touch sensor, and the first and second air pressure sensors, to receive detected information to apply operation control signals to the first and second air pressure pumps and the first and second solenoid valves.

2. The exercise apparatus for helping growth through stretching and stimulation of a knee joint area, according to claim 1,
wherein the stimulation generation unit includes any one or more than one of a vibration motor that applies vibration stimulation, a low-frequency electrode that applies low-frequency electrical stimulation, or a solenoid actuator that applies tapping stimulation by repeated beating.

3. The exercise apparatus for helping growth through stretching and stimulation of a knee joint area, according to claim 1,
wherein the controller includes a fixation control unit as a control element that receives a detection signal from the capacitive touch sensor to inflate the upper and lower limb air cells, thereby allowing the user's thigh and calf to be constrained and fixed, that applies a control signal to the first solenoid valve so that the upper and lower air cells are filled with air, and that controls the supply until an air pressure value detected through the first air pressure sensor reaches a preset value;
a traction control unit as a control element that, when the inflation of the upper and lower limb air cells by the fixation control unit is completed, applies a control signal to the second air pump to inflate the expandable air cell to space the upper and lower limb holders from each other so that a traction force is exerted, that applies the control signal to the second air pump to fill the expandable air cell with air, and that controls the supply until an air pressure value detected through the second air pressure sensor reaches a preset value; and
a popliteal stimulation control unit that applies power to the stimulation generation unit to controls the stimulation to be exerted on the popliteal part when the traction operation by the traction control unit is completed.

4. The exercise apparatus for helping growth through stretching and stimulation of a knee joint area, according to claim 2,
wherein the controller includes a timer that measures time, and
a repeated traction control unit that is connected to the second air pressure sensor and that applies a control signal to the second solenoid valve so that the upper and lower limb holders are spaced apart close to each other by exhausting 50 to 90% of the air in the expandable air cell when the supply of the air to the expandable air cell is completed, and then applies a control signal to the second air pump so that the upper and lower limb holders are displaced in directions apart from each other by re-injecting the air into the expandable air cell until the preset value is reached, thereby controlling the inflation and contraction of the expandable air cell so as to repeat by a preset number of times.

5. The exercise apparatus for helping growth through stretching and stimulation of a knee joint area, according to claim 1,
wherein a body temperature sensor that detects a user's body temperature is provided on one side of the main body, and
the body temperature sensor is circuit-connected to the controller so that the body temperature measured by the temperature sensor is applied to the controller.

6. The exercise apparatus for helping growth through stretching and stimulation of a knee joint area, according to claim 1,
wherein a blood pressure sensor that detects a user's blood pressure is provided on one side of the main body, and
the blood pressure sensor is circuit-connected to the controller so that the blood pressure measured by the blood pressure sensor is applied to the controller.
